(19) United States
(12) Patent Application Publication
(10) Pub. No.: US 2017/0201765 A1
(43) Pub. Date: Jul. 13, 2017

(54) VIDEO STREAM DECODING METHOD AND VIDEO STREAM DECODING SYSTEM

(71) Applicant: MStar Semiconductor, Inc., Hsinchu Hsien (TW)

(72) Inventors: Yi-Chin HUANG, Zhubei City (TW); Yi-Shin TUNG, Zhubei City (TW)

(21) Appl. No.: 15/015,232

(22) Filed: Feb. 4, 2016

(30) Foreign Application Priority Data
Jan. 11, 2016 (TW) 105100711

(51) Int. Cl. H04N 19/48; H04N 19/423; H04N 19/91; H04N 19/172; H04N 19/176

(52) U.S. Cl. CPC H04N 19/48; H04N 19/172; H04N 19/176; H04N 19/91; H04N 19/423

(57) ABSTRACT

A video stream decoding system includes a video decoder, a frame encoder, a buffer and a frame decoder. The video decoder receives a video stream, and decodes an encoded frame in the video stream to generate a frame. The frame includes a plurality of coding blocks. The frame encoder includes a first compressor, a second compressor and a selector. The first compressor compresses an image data group in a coding block according to a first compression algorithm to generate a first compressed image data group. The second compressor compresses the image data group in the coding block according to a second compression algorithm to generate a second compressed image data group. The first compression algorithm is different from the second compression algorithm.

This application claims the benefit of Taiwan application Serial No. 105100711, filed Jan. 11, 2016, the subject matter of which is incorporated herein by reference.

### BACKGROUND OF THE INVENTION

Field of the Invention

The invention relates in general to a video stream processing method and a video stream processing system, and more particularly to a video stream decoding method and a video stream decoding system.

Description of the Related Art

FIG. 1 shows a schematic diagram of a conventional video stream decoding system 100. For example, the video stream decoding system 100 is disposed in a television or a computer. The video stream decoding system 100 includes a video decoder 110, a frame encoder 120, a buffer 130 and a frame decoder 140. The frame encoder 120 includes a compressor 122, and the frame decoder 140 includes a decompressor 142. The video decoder 110 receives a video stream that includes a plurality of encoded frames. The video decoder 110 decodes the encoded frame to generate a frame that includes a plurality of coding blocks. A coding block is a smallest unit that can be independently encoded or decoded. The frame encoder 120 encodes the frame by a unit of one coding block. The compressor 122 in the frame encoder 120 compresses an image data group in a coding block in the frame to generate a compressed image data group. For example, the compressor 122 is a fixed length encoder, or a variable length encoder. The compressor 122 then outputs the compressed video data group to the buffer 130 via a bus B1. The compressed image data group is temporarily stored in the buffer 130 as a reference for the video decoder 110 in a decoding process. When the video decoder 110 needs to refer to the compressed image data group in the decoding process, the buffer 130 outputs the compressed image data group to the frame decoder 140 via the bus B1. The decompressor 142 in the frame decoder 140 decompresses the compressed image data group to generate the image data group, and outputs the image data group to the video decoder 110 as a reference for the video decoder 110 in the decoding process.

Generally speaking, the compression efficiency of the variable length encoding algorithm is higher. However, for an image data group having small changes in pixel values, the compression efficiency of the variable length encoding algorithm may be lower than that of the fixed length encoding algorithm. When the compressor 122 is a fixed length encoder or a variable length encoder, the amount of bandwidth usage of the bus B1 cannot be reduced as an appropriate encoder cannot be selected for different image data groups.

### SUMMARY OF THE INVENTION

The invention is directed to a video stream decoding method and a video stream decoding system capable of selecting an appropriate encoder for different image data groups to enhance the compression efficiency and to accordingly reduce the amount of bandwidth usage of a bus.

According to an aspect of the present invention, a video stream decoding system is provided. The system includes a decoder, a frame encoder, a buffer and a frame decoder. The video decoder receives a video stream, and decodes an encoded frame in the video stream to generate a frame. The frame includes a plurality of coding blocks. The frame encoder includes a first compressor, a second compressor and a selector. The first compressor compresses an image data group in a coding block according to a first compression algorithm to generate a first compressed image data group. The second compressor compresses the image data group in the coding block according to a second compression algorithm to generate a second compressed image data group. The first compression algorithm is different from the second compression algorithm. The selector outputs one of the first compressed image data group and the second compressed image data group to the buffer according to the first compressed image data group and the second compressed image data group. The buffer temporarily stores the outputted compressed image data group. The frame decoder receives the outputted compressed image data from the buffer, decompresses the first compressed image data to generate the image data group, and outputs the image data group to the video decoder. The video decoder decodes another encoded frame in the video stream by referring to the image data group.

According to another aspect of the present invention, a video stream decoding method is provided. The method includes following steps. A video stream including a plurality of encoded frames is received. An encoded frame in the video stream is decoded to generate a frame, which includes a plurality of coding blocks. An image data group in a coding block is compressed according to a first compression algorithm to generate a first compressed image data group. The image data group in the coding block is compressed according to a second compression algorithm to generate a second compressed image data group. The first compression algorithm is different from the second compression algorithm. One of the first compressed image data group and the second compressed image data group is outputted to a buffer according to the first compressed image data group and the second compressed image data group. The outputted compressed image data group is received from the buffer, and is decompressed to generate the image data group. Another encoded frame in the video stream is decoded by referring to the image data group.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a conventional video stream decoding system;

FIG. 2 is a schematic diagram of a video stream decoding system according to an embodiment of the present invention; and

FIG. 3 is a flowchart of a video stream decoding method according to an embodiment of the present invention.

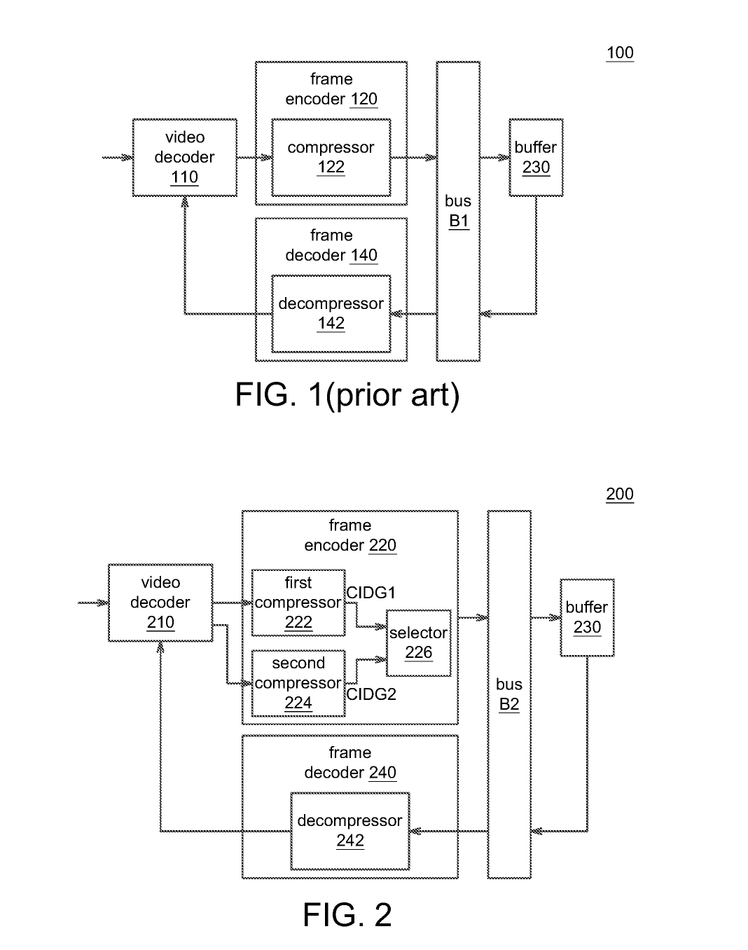

### DETAILED DESCRIPTION OF THE INVENTION

In the present invention, the same image data is compressed according to different compression algorithms by two or more different compressors to generate two or more compressed image data groups, and the compressed image data group with the best compression efficiency is outputted to a buffer, thereby reducing the amount of bandwidth usage.

FIG. 2 shows a schematic diagram of a video stream decoding system 200 according to an embodiment of the present invention. For example, the video stream decoding system 200 may be disposed in a television or a computer. The video stream decoding system 200 includes a video decoder 210, a frame encoder 220, a buffer 230 and a frame decoder 240. The frame encoder 220 includes a first compressor 222, a second compressor 224 and a selector 226. The video decoder 210, the frame encoder 220, the buffer 230 and the frame decoder 240 are realized by hardware circuits.

The video decoder 210 receives a video stream, which includes a plurality of encoded frames. The video decoder 210 decodes an encoded frame in the video stream to generate a frame that includes a plurality of coding blocks. A coding block is a smallest unit that can be independently encoded or decoded by the frame encoder 220 and the frame decoder 240.

The frame encoder 220 encodes the frame in a unit of one coding block, and outputs a compressed image data group to the buffer 230. More specifically, the first compressor 222 in the frame encoder 220 compressed an image data group in a coding block in the frame according to a first compression algorithm to generate a first compressed image data group CIDG1, and outputs the first compressed image data group CIDG1 to the selector 226 in the frame encoder 220. The second compressor 224 in the frame encoder 220 compresses the image data group in the coding block in the frame to generate a second compressed image data group CIDG2, and outputs the second compressed image data group CIDG2 to the selector 226. The first compression algorithm of the first compressor 222 is different from the second compression algorithm of the second compressor 224. For example, the first compressor 222 is a fixed length encoder, and the first compression algorithm is a fixed length encoding method; the second compressor 224 is a variable length encoder, and the second compression algorithm is a variable length encoding method.

The selector 226 outputs one of the first compressed image data group CIDG1 and the second compressed image data group CIDG2 according to the first compressed image data group CIDG1 and the second compressed image data group CIDG2. For example, the selector 226 may learn the amount of compressed data of the first compressed image data group CIDG1 according to the first compressed image data group CIDG1, and the amount of compressed data of the second compressed image data group CIDG2 according to the second compressed image data group CIDG2. The selector 226 then compares the amount of compressed data of the first compressed image data group CIDG1 and the amount of compressed data of the second compressed image data group CIDG2 to determine respective compression efficiencies of the first compressor 222 and the second compressor 224. If the amount of compressed data of the first compressed image data group CIDG1 is smaller than the amount of compressed data of the second compressed image data group CIDG2, the selector 226 determines that the compression efficiency of the first compressor 222 is greater than the compression efficiency of the second compressor 224 for the image data group in the coding block. Thus, the selector 226 outputs the first compressed image data group CIDG1 to the buffer 230 via a bus B2. If the amount of compressed data of the second compressed image data group CIDG2 is smaller than the amount of compressed data of the first compressed image data group CIDG1, the selector 226 accordingly determines that the compression efficiency of the second compressor 224 is greater than the compression efficiency of the first compressor 222. Thus, the selector 226 outputs the second compressed image data group CIDG2 to the buffer 230 via a bus B2. The first compressed image data group CIDG1 (or the second compressed image data group CIDG2) is temporarily stored in the buffer 230.

When the video decoder 210 needs to refer to the image data group in the coding block in a decoding process, the frame decoder 240 receives the first compressed image data group CIDG1 (or the second compressed image data group CIDG2) temporarily stored in the buffer 230 via bus B2, decompresses the first compressed image data group CIDG1 (or the second compressed image data group CIDG2) to generate the image data group, and outputs the image data group to the video decoder 210. The video decoder 210 decodes another encoded frame in the frame according to the image data group.

As such, the frame encoder 220 may select an appropriate encoder for different image data groups to enhance the compression efficiency and to reduce the amount of bandwidth usage of the bus B2.

In one embodiment, for the same image data, if the compression efficiencies of a fixed length encoder (e.g., the first compressor 222) and a variable length encoder (e.g., the second compressor 224) are equal (e.g., the amount of data of the first compressed image data group CIDG1 is equal to the amount of data of the second compressed image data group CIDG2), the selector 226 may select to output the compressed image data of the fixed length encoder (e.g., the first compressed image data group CIDG1) to the buffer for the decoder 210 to refer to in a subsequent decoding process. Because the decompression speed of the compressed image data group obtained through the fixed length compression algorithm is greater than the decompression speed of the compressed image data group obtained through the variable length compression algorithm, the decoding speed of the video decoder 210 can be increased.

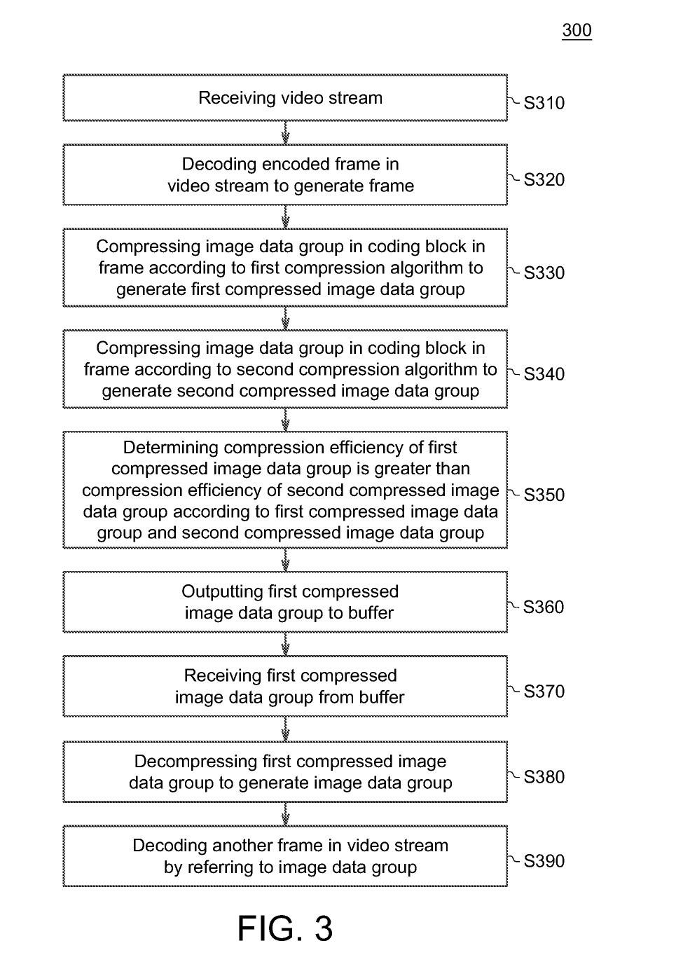

FIG. 3 shows a flowchart of a video stream decoding method according to an embodiment of the present invention. Referring to FIG. 3, the video stream decoding method 300 includes following steps.

In step S310, a video stream is received.

In step S320, an encoded frame in the video stream is decoded to generate a frame.

In step S330, an image data group in a coding block in the frame is compressed according to a first compression algorithm to generate a first compressed image data group.

In step S340, the image data group in the coding block in the frame is compressed according to a second compression algorithm to generate a second compressed image data group.

In step S350, it is determined that the compression efficiency of the first compression algorithm is greater than the compression efficiency of the second compression algorithm according to the first compressed image data group and the second compressed image data group.

In step S360, the first compressed image data group is outputted to a buffer.

In step S370, the first compressed image data group is received from the buffer.

In step S380, the first compressed image data group is decompressed to generate the image data group.

In step S390, another encoded frame in the video stream is decoded by referring to the image data group.

The video stream decoding method 300 may be performed by the video stream decoding system 200. Steps S310, S320 and S390 may be performed by the video decoder 210, step S330 may be performed by the first compressor 222 in the frame encoder 220, step S340 may be performed by the second compressor 224 in the frame encoder 220, steps S350 and S360 may be performed by the selector 226 in the frame encoder 220, and steps S370 and S380 may be performed by the decompressor 242 in the frame decoder 240. One person skilled in the art can easily understand details for performing the video stream decoding method 300 by the video stream decoding system 200 with reference to the description associated with the video stream decoding system 200 Such details are omitted herein.

Steps S330 and S340 may be simultaneously performed. For example, while the first compressor 122 in the frame encoder 120 compresses an image data group in a coding block in the frame according to a first compression algorithm, the second compressor 124 in the frame encoder 120 may at the same time compress the image data group in the coding block in the frame according to a second compression algorithm.

In one embodiment, the first compression algorithm is a fixed length encoding method, and the second compression algorithm is a variable length encoding method. For example, the first compressor 222 is a fixed length encoder, and the second compressor 224 is a variable length encoder. In another embodiment, the first compression algorithm is a variable length encoding method, and the second compression algorithm is a fixed length encoding method. For example, the first compressor 222 is a variable length encoder, and the second compressor 224 is a fixed length encoder.

It should be noted that, in the above embodiments, although the video decoder 210, the frame encoder 220 and the frame decoder 240 are realized by hardware circuits, such examples are not to be construed as limitations to the present invention. In other words, the video decoder 210, the frame encoder 220 and the frame decoder 24 may also be realized by a processor in conjunction with software programs.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video stream decoding system, comprising:
a video decoder, receiving a video stream and decoding an encoded frame in the video stream to generate a frame, the frame comprising a plurality of coding blocks;
a frame encoder, comprising:
a first compressor, compressing an image data group in a coding block according to a first compression algorithm to generate a first compressed image data group;
a second compressor, compressing the image data group in the coding block according to a second compression algorithm to generate a second compressed image data group, wherein the first compression algorithm is different from the second compression algorithm; and
a selector, outputting one of the first compressed image data group and the second compressed image data group to a buffer according to the first compressed image data group and the second compressed image data group;
the buffer, temporarily storing the outputted compressed image data group; and
a frame decoder, receiving the outputted compressed image data group from the buffer, decompressing the outputted compressed image data group to generate the image data group, and outputting the image data group to the video decoder for the video decoder to decode another encoded frame in the video stream by referring to the image data group.

2. The video stream decoding system according to claim 1, wherein the selector outputting the one of the first compressed image data group and the second compressed image data group to the buffer according to the first compressed image data group and the second compressed image data group comprises:
outputting the first compressed image data group to the buffer according to a determination result indicating that an amount of compressed data of the first compressed image data group is smaller than an amount of compressed data of the second compressed image data group.

3. The video stream decoding system according to claim 2, wherein the first compressor is a fixed length encoder, and the second compressor is a variable length encoder.

4. The video stream decoding system according to claim 2, wherein the first compressor is a variable length encoder, and the second compressor is a fixed length encoder.

5. The video stream decoding system according to claim 1, wherein the selector outputting the one of the first compressed image data group and the second compressed image data group to the buffer according to the first compressed image data group and the second compressed image data group comprises:
the selector outputting the first compressed image data group to the buffer when an amount of compressed data of the first compressed image data group is equal to an amount of compressed data of the second compressed image data group, wherein the first compressor is a fixed length encoder and the second compressor is a variable length encoder.

6. A video stream decoding method, comprising:
receiving a video stream, the video stream comprising a plurality of encoded frames;
decoding an encoded frame in the video stream to generate a frame, the frame comprising a plurality of coding blocks;
compressing an image data group in a coding block according to a first compression algorithm to generate a first compressed image data group;
compressing the image data group in the coding block according to a second compression algorithm to generate a second compressed image data group, wherein the first compression algorithm is different from the second compression algorithm;
outputting one of the first compressed image data group and the second compressed image data group to a buffer according to the first compressed image data group and the second compressed image data group;
receiving the outputted compressed image data group from the buffer;
decompressing the outputted first compressed image data group to generate the image data group; and
decoding another encoded frame in the video stream by referring to the image data group.

7. The video stream decoding method according to claim 6, wherein the step of outputting the one of the first compressed image data group and the second compressed image data group to the buffer according to the first compressed image data group and the second compressed image data group comprises:
outputting the first compressed image data group to the buffer according to a determination result indicating that an amount of compressed data of the first compressed image data group is smaller than an amount of compressed data of the second compressed image data group.

8. The video stream decoding method according to claim 7, wherein the first compression method is a fixed length encoding method, and the second compression algorithm is a variable length encoding method.

9. The video stream decoding method according to claim 7, wherein the first compression method is a variable length encoding method, and the second compression algorithm is a fixed length encoding method.

10. The video stream decoding method according to claim 6, wherein the step of outputting the one of the first compressed image data group and the second compressed image data group to the buffer according to the first compressed image data group and the second compressed image data group comprises:
outputting the first compressed image data group to the buffer when an amount of compressed data of the first compressed image data group is equal to an amount of compressed data of the second compressed image data group, wherein the first compressor is a fixed length encoder and the second compressor is a variable length encoder.
